(19) United States
(12) Patent Application Publication
(10) Pub. No.: US 2015/0347188 A1
(43) Pub. Date: Dec. 3, 2015

(54) DELEGATED BUSINESS PROCESS MANAGEMENT FOR THE INTERNET OF THINGS

(71) Applicant: APPSFREEDOM, INC., Chandler, AZ (US)

(72) Inventors: Vaidyanathan IYER, Chandler, AZ (US); Vikas GUPTA, Naperville, IL (US)

(73) Assignee: APPSFREEDOM, INC., Chandler, AZ (US)

(21) Appl. No.: 14/727,425

(22) Filed: Jun. 1, 2015

Related U.S. Application Data
(60) Provisional application No. 62/005,738, filed on May 30, 2014.

(51) Int. Cl. G06F 9/48; G06Q 10/06; H04L 29/08

(52) U.S. Cl. CPC G06F 9/4881; H04L 67/10; H04L 67/16; G06Q 10/067

(57) ABSTRACT

A delegated business process management system for the Internet of Things is provided. The system includes a plurality of platform levels, wherein a business process is created and managed in a first platform level. The first platform level can delegate the ability and authorization to perform a task of a created business process to a second platform level, wherein the ability and authorization to perform the task includes the ability and authorization to communicate with other systems to obtain needed data. Further, the ability and authorization to perform the task includes the ability and authorization to delegate sub-tasks to a third platform level, wherein the ability and authorization to perform the sub-task includes the ability and authorization to communicate with other systems to obtain needed data. The ability to delegate to additional platform levels may occur for any number of possible platform levels that are available.

### CROSS REFERENCE TO RELATED APPLICATION[S]

This application claims priority to U.S. Provisional Patent Application entitled “DELEGATED BUSINESS PROCESS MANAGEMENT FOR THE INTERNET OF THINGS,” Ser. No. 62/005,738, filed 30 May 2014, the disclosure of which is hereby incorporated entirely herein by reference.

### BACKGROUND OF THE INVENTION

1. Technical Field

This invention relates generally to business process management and more particularly to a delegated business process management.

2. State of the Art

A business process includes an objective and ends with achievement of the business objective. Generally, conventional business processes include several sub-processes, which have their own attributes, wherein each sub-process operates to achieve the overall business objective. These business processes are designed to add value to a customer by increasing the effectiveness of the services provided by the company.

Conventional business process management executes each of the sub-processes or tasks in a single platform level, such as in a management module. The management module may be accessible by other devices in order to obtain the necessary input to perform the sub-processes. These conventional business process management systems are lacking in their ability to adapt to an ever growing phenomena referred to as the Internet of Things wherein electronic devices are “smart” and “connected,” thereby communicating with each other.

Accordingly, there is a need in the field of business process management for a delegated business process management.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of an architecture of a delegated business process management for the Internet of Things; and

FIG. 2 is a flow chart of a business process.

### DETAILED DESCRIPTION OF EMBODIMENTS OF THE INVENTION

As discussed above, embodiments of the present invention relate to a delegated business process management for the Internet of Things. Generally, the present invention allows for smart devices to delegate performance of a task to another smart device.

In an Internet of Things (“IOT”) environment, all the various devices we use in our everyday life become “smart” and “connected.” A Smart Watch, Smart Glasses, a Smart Thermostat, Smart Clothing, a Smart Car and the like are examples of the IOT phenomena. The IOT phenomena is one the biggest phenomena happening in our lives, but it is not a single big innovation that will happen over-night. Instead, it is a collection of many small innovations, that are coming together to create the IOT phenomena. These small innovations may seem disconnected at the moment, but it's not far-fetched to think that these smart devices are not only connected but will have innovations built on top of these innovations to have an IOT world where almost everything we touch or use will talk “intelligently” to everything else.

There is a need to change or replace all the enterprise applications that exist and are in place. It's not possible to rip apart all systems and design new ones to fit into this IOT World. More-over there are some fundamental differences between the IOT devices (like processing power, space, etc.) that will never match the existing systems capability. So in all likelihood, we will need a “bridge” to span the traditional enterprise systems with the IOT world. This bridge needs to be something fundamental in architecture to leverage the best of both worlds.

In order to determine what is required, it is important to look at the fundamentals of a conventional enterprise application. Fundamentally an enterprise application consists of 3 layers—A User Interface Layer (“UI”), an Application Layer (“AL”) and a Database Layer (“DB”). Now typically all these layers are in a single logical box for a typical enterprise application. Since architecture has evolved to put these three layers in 3 or more logical boxes, i.e. you can have the database layer in a logical box, an application layer in a logical box and the UI in another logical box, all three interacting with each other. There are many variants of this model in addition to a typical business application such as a BPM application or an Integration application.

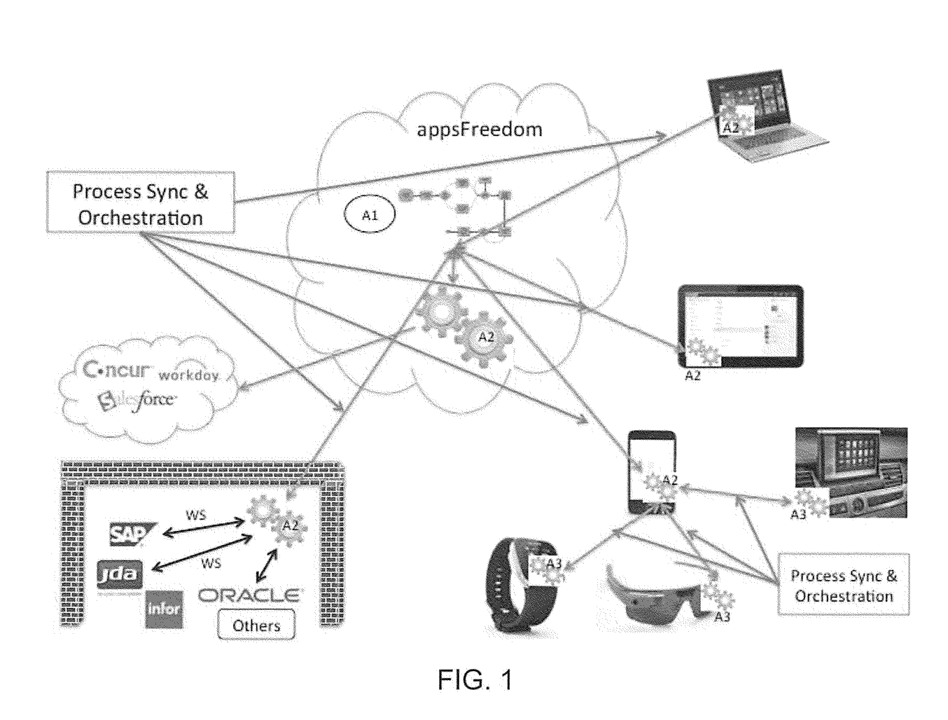

Discussing further what is required, the system comprises an architecture where the application layer is broken into two parts; a process design/management layer and a process execution layer, wherein this process execution layer is distributed in various devices to execute the given business processes in an autonomous fashion Think of taking the business process layer and slicing it in half, horizontally where the top part is the logical design or flow and the bottom part is the execution, wherein this execution happens in various devices. Referring to FIG. 1, a top layer, shown as A1, is where all the business logic and design resides and a bottom layer, shown as A2, is where the execution of the logic occurs. The bottom execution layer A2 can be replicated to sub-levels like A3, A4, and so on.

The UI and the DB will change accordingly to support this architecture. In other words, depending on the execution layer, it may or may not need a UI and/or a DB.

It should be understood that the context of this disclosure is specific to running enterprise business applications in the IOT world.

Use Case 1 is presented as a non-limiting example: A sales person walks into an existing customer's office, with a Smart Watch on his wrist and a Smart Phone in his pocket. As soon as he/she enters the building or is in the vicinity of the customer, the sales person needs to see pop-up messages of any immediate problems or service tickets the customer may have raised.
The pop-up messages should come up in the Smart Watch if he/she is wearing the Smart Watch.
The same pop-up messages should NOT come up in the Smart Phone if he/she has already seen some of the pop-up messages in the Smart Watch and acknowledged them.
If the salesperson picks up the Smart Phone and starts interacting in the Smart Phone, further pop-up messages should be seen in the Smart Phone and NOT the Smart Watch.
The pop-up messages the user has acknowledged in the Smart Phone should not be seen again in the Smart Watch.
If the sales person did not wear the Smart Watch on any particular day, then all pop-up messages should be seen only on the Smart Phone and NOT the Smart Watch.
The Smart Watch may or may not be internet enabled. It could be only be connected to Smart Phone via blue-tooth.

The complete business process utilizing a delegated BPM comprises the following steps:
Find the context/location etc. of the sales person and initiate the process;
The process includes finding relevant data from multiple systems (Service management, Order management, CRM, etc.) that could be in multiple locations, process the relevant data from multiple systems, apply business rules, authorizations etc., and combine or merge and consolidate the data and send it back to a “Delegated Device” (A Smart Phone in this case if the Smart Watch is only blue tooth enabled, which by the way no one would know what type of Smart Watch each sales person may be wearing).
Once the delegated device receives relevant information, the delegated device decides which information to send to the user and via which device and at what time. Also based on the engagement with the sales person, the delegated device may request more information from enterprise systems.

As you can see, the conventional system architecture of DB, AL & UI in a box will not support this requirement. One could argue that a conventional BPM system could support it as it's designed to execute multiple process steps in various systems/devices but the fundamental concept is it must also act as the central clearing house to integrate with various systems and tell what each system should do at what time. Accordingly, there is no concept of “delegation” in conventional BPM.

In order to support this use case 1, what is needed is a system where the business logic is designed in one place much like the current BPM, but with the capability to delegate certain business processes and decisions to satellite systems, such as, but not limited to, a Smart Phone that can make certain decisions based on Smart Watch and other devices connected to it.

The process defines and identifies all systems in design time but the course of execution of business tasks is determined at runtime. This task determination is done, by delegated systems, based on their availability or non-availability. For example, and not as a limitation, the central processing engine or BPM may not even know if the sales person is wearing a Smart Watch on a particular day or what type of Smart Watch is he/she wearing. However, the Smart Phone will know as soon as the Smart Watch is connected to the Smart Phone and the Smart Phone can make decisions and execute a business sub-process based on what devices are connected to the Smart Phone. For example, a Smart Car, a Smart Watch and Smart Glasses could be connected to the Smart Phone and if the user is driving, then the messages may pop-up on the car dashboard or Smart Glasses or if he/she is out of the car, then on the Smart Watch and so forth.

Referring to the drawings, FIG. 1 depicts and embodiment of an architecture of a delegated business process management for the Internet of Things world.

Elements of the architecture may comprise:

A1=The Business process designed and managed in one place like a Cloud application. Generally the Cloud application A1 may be a central application hosted by a cloud provider and delivered as a software-as-a-service (SaaS) application.

A2=Parts of the business process are executed in different platforms. For example and without limitation, different platforms A2 of the system architecture may be referred to as a multi-channel level that may include inside a firewall (On-Premise Applications), a computer, a tablet, a Smart Phone and different business applications like SAP, Salesforce, Oracle, etc., wherein each includes a memory for storing data and software applications, a processor for executing software code and performing parts of the business process, a display for displaying information and requests regarding the BPM and an input mechanism for inputting data into the device for performing the business process. The A2 in some cases may integrate with other applications to get data.

A3=Parts of the business process are located underneath the level of A2 executed in different platforms, but controlled by A2 process. For example, and not by way of limitation, level A3 of the system may be referred to as a subsequent multi-channel level wherein the business process may be executed in a Smart Watch, Smart Glasses & a Smart Car and is controlled and managed by an A2 process in the Smart Phone, wherein each includes a memory for storing data and software applications, a processor for executing software code and performing parts of the business process, a display for displaying information and requests regarding the BPM and an input mechanism for inputting data into the device for performing the business process. In this case, part of the management of the process is “delegated” to the Smart Phone.

A2 and A3 can also have multi-devices in each channel. For e.g., multiple Smart Watches and multiple Smart Glasses could be connected to the same Smart Phone. In this case, Smart Watch and Smart Glasses is the Channel and the various individual Smart Watches and Smart Glasses are Devices. In at least this way, the system, comprising of a central business process management system with multi-channels and multi-devices is a delegated business process management system.

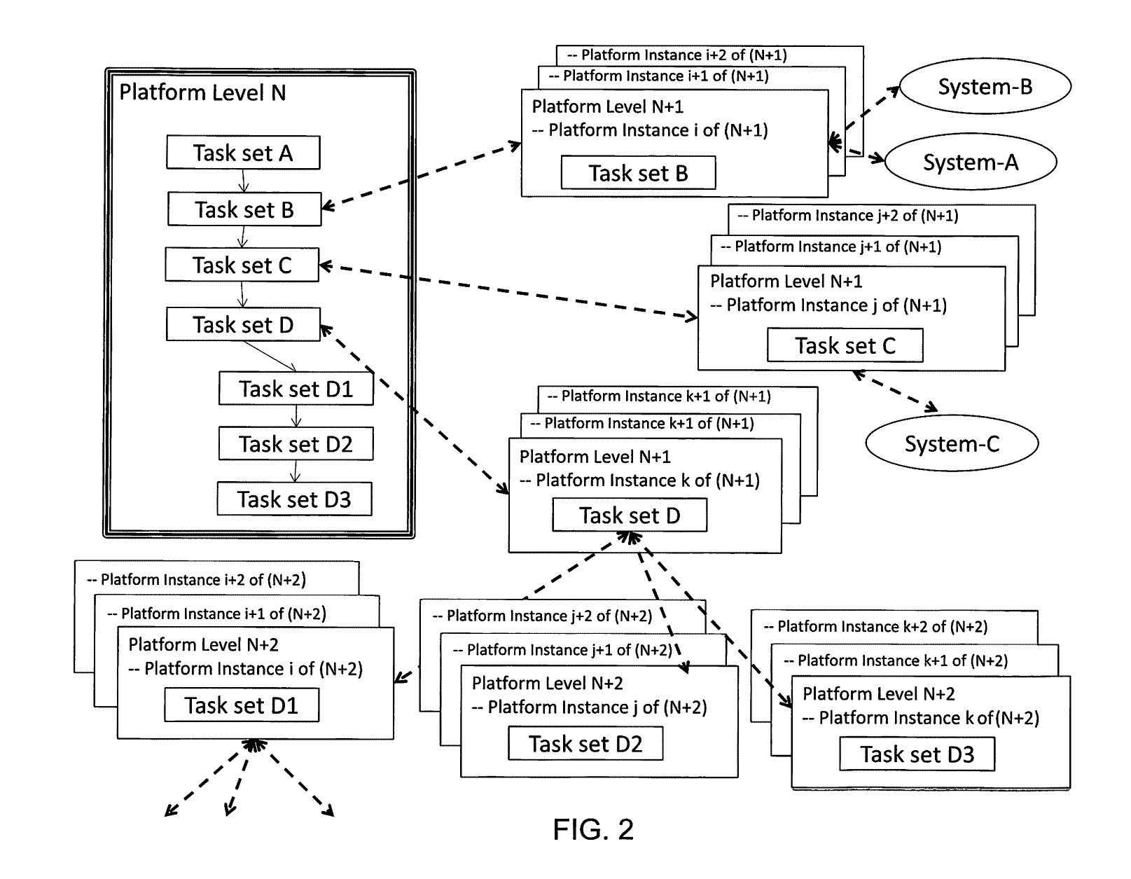

To provide a further example of the operation of a delegation business process management system, FIG. 2 depicts a delegated business process management. The business process may include a set of tasks, such as Task set A, Task set B, Task set C and Task set D. Task set D may also include sub-task sets, such as Task set D1, Task set D2 and Task set D3. The business process is designed and managed in Platform Level N, where N represents an initial platform level, such as a Cloud platform level. In operation, Platform Level N can perform all of the Tasks and subtasks of the business process, but in order to more efficiently and effectively utilize technology and the growing technology in the IOT world, embodiments of the present invention provide for a delegated business process management. In the delegated business process management, Platform Level N can determine what Tasks need to be performed on the Platform Level N and which tasks can be delegated. In this example, Task set A is set to be performed on Platform Level N and Task set B, Task set C and Task set D are each delegated to Platform Level N+1.

In this example, Task set B is delegated to Platform Instance i of Platform Level N+1, Task set C is delegated to Platform Instance j of Platform Level N+1, and Task set D is delegated to Platform Instance k of Platform Level N+1. Platform Instances i, j and k are different types of platforms, referred as Multi-Channels, within Platform Level N+1, for example, a Smart Phone, a tablet, a laptop, etc. Within each Platform Instance, there may be additional instances, like Platform Instance i+1 and Platform Instance i+2, Platform Instance j+1 and Platform Instance j+2, and Platform Instance k+1 and Platform Instance k+2, referred as Multi-Devices. The various additional instances within each Platform Instance may represent differing operating systems within that type of Platform Instance. A Platform Instance is generally understood to be a computing device.

In operation, delegation of tasks from Platform Level N to Platform Level N+1 includes delegation of abilities for Platform Level N+1 to accomplish and complete the tasks. For example, Platform Instance i of Platform Level N+1 has been delegated Task set B and also delegated the ability and authorization to communicate with other systems, such as System A and System B in order to obtain data and/or other information necessary to complete Task set B. Further, Platform Instance j of Platform level N+1 has been delegated Task set C and also delegated the ability and authorization to communicate with other systems, such as System C to obtain data and/or other information necessary to complete Task set C. This is a shift from conventional business process management where all communications with other systems happen on the Platform Level N.

The delegation of ability and authorization is intended to mean the delegation of relevant business task information and relevant data for the subsequent platform to execute the task. This delegation of ability and authorization also includes delegating the power to a Platform Level to communicate with other systems in order to obtain any needed data and information to execute the task. The delegation of ability and authorization may also include the power to delegate one or more subtasks to another Platform Level, along with the relevant business task information and relevant data for the subsequent platform to execute the subtasks, including the power to communicate with other systems as needed. As shown in FIG. 2, Task set D has been delegated to Platform instance k of Platform Level N+1, which includes at least the ability and authorization to communicate with other systems and the ability and authorization to delegate sub tasks to Platform Level N+2 including the ability and authorization to communication with other systems to obtain data and/or information necessary to accomplish the sub-task.

For example, Task set D includes sub-tasks labeled as Task set D1, task set D2 and Task set D3. Task set D1 is delegated to Platform Instance i of Platform Level N+2, Task set D2 is delegated to Platform Instance j of Platform Level N+2, and Task set D3 is delegated to Platform Instance k of Platform Level N+2. Platform Instances i, j and k are different types of platforms (Multi-Channels) within Platform Level N+2, for example, a Smart Watch, a Smart Glasses, a Smart Car, etc. Within each Platform Instance, there may be additional instances, like Platform Instance i+1 and Platform Instance i+2, Platform Instance j+1 and Platform Instance j+2, and Platform Instance k+1 and Platform Instance k+2 (Multi-Devices). The various additional instances (Multi-Devices) within each Platform Instance (Multi-Channels) may represent differing operating systems within that type of Platform Instance.

In operation, delegation of sub-tasks from Platform Instance i of Platform Level N+1 to Platform Level N+2 includes delegation of abilities and authorizations for Platform Level N+2 to accomplish and complete the sub-tasks. For example, Platform Instance i of Platform Level N+2 has been delegated Task set D1 and also delegated the ability and authorization to communicate with other systems (represented by arrows in FIG. 2) in order to obtain data and/or other information necessary to complete Task set D1. Further, Platform Instance j of Platform Level N+2 has been delegated Task set D2 and Platform Instance K of Platform Level N+2 has been delegated Task set D3. This is a shift from conventional business process management where all communications with other systems happen on the Platform Level N.

Accordingly, as opposed to conventional business process management where any device operating on the various Platform Levels would need to communicate directly to Platform Level N through a user interface over a network connection in order to accomplish the tasks of the business process, embodiments of a delegated business process management allow for other devices to perform tasks that require only the ability of a particular device on a particular Platform Level to accomplish the tasks. It will be understood that according to embodiments, the delegated business process management system of the present invention can determine what devices are available on the various levels and delegate only to the levels that are available or that are needed in order to accomplish the task. Further, while it is shown that there are 3 Platform Levels, it is contemplated that additional Platform Levels may be possible and the delegation occurs in similar fashion throughout the Platform Levels and Platform Instances. This delegation of ability and authority to various devices along multiple Platform Levels allows for communication of device in the IOT world and opens up a multitude of possibilities for accomplishing business processes through delegation in order to provide for an effective and mobile approach to management of business processes.

Another embodiment of the present invention includes A method of operating a delegated business process management system. The method comprises designing and managing a business process having a plurality of tasks at a first platform level; delegating a task of the plurality of tasks from the first platform level with accompanying ability and authorization to a device of a particular platform instance of a second platform level, wherein the accompanying ability and authorization for the device of the second level includes the ability and authorization to communicate with other systems to obtain data and to delegate the ability and authorization to complete a sub-task to a third platform level; and delegating the sub-task from the device on the second platform level with accompanying ability and authorization to a device of a particular platform instance of the third platform level, wherein the accompanying ability and authorization includes the ability and authorization for the device of the third platform level to communicate with other systems to obtain data. The method may further comprise completing the tasks and sub-tasks on the respective platform level and communicating same to the first platform level.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed.

Many modifications and variations are possible in light of the teachings above without departing from the spirit and scope of the forthcoming claims.

1. A delegated business process management system comprising:
a first platform level, wherein a business process having a plurality of tasks is designed and managed within the first platform level;
a second platform level, wherein the second platform level includes different platform instances; and
a third platform level, wherein the third platform level includes different platform instances, and wherein:
the first platform level delegates a task with accompanying ability and authorization to a device of a particular platform instance of the second platform level, wherein the accompanying ability and authorization for the device of the second level includes the ability and authorization to communicate with other systems to obtain data and to delegate the ability and authorization to complete a sub-task to the third platform level; and
a device on the second platform level delegates the sub-task with accompanying ability and authorization to a device of a particular platform instance of the third platform level, wherein the accompanying ability and authorization includes the ability and authorization for the device of the third platform level to communicate with other systems to obtain data.

2. The system of claim 1, wherein the first platform level comprises a Cloud platform level.

3. The system of claim 1, wherein the second platform level comprises multi-channels.

4. The system of claim 3, wherein one of the multi-channels comprises a Smart Phone.

5. The system of claim 3, wherein one of the multi-channels comprises a tablet.

6. The system of claim 3, wherein one of the multi-channels comprises a laptop.

7. The system of claim 1, wherein the different platform instances of the second platform level comprises different operating systems.

8. The system of claim 1, wherein the third platform level comprises multi-channels.

9. The system of claim 8, wherein one of the multi-channels comprises a Smart Watch.

10. The system of claim 8, wherein one of the multi-channels comprises a Smart Glasses.

11. The system of claim 8, wherein one of the multi-channels comprises a Smart Car.

12. The system of claim 1, wherein the different platform instances of the third platform level comprises different operating systems.

13. A delegated business process management system comprising:
a first platform level, wherein a business process having a plurality of tasks is designed and managed within the first platform level;
a second platform level, wherein the second platform level includes different platform instances; and
a third platform level, wherein the third platform level includes different platform instances, and wherein:
the first platform level delegates a task with accompanying ability and authorization to a device of a particular platform instance of the second platform level, wherein the accompanying ability and authorization for the device of the second level includes the ability and authorization to delegate the ability and authorization to complete a sub-task to the third platform level; and
a device on the second platform level delegates the sub-task with accompanying ability and authorization to a device of a particular platform instance of the third platform level, wherein the accompanying ability and authorization includes the ability and authorization for the device of the third platform level to complete the sub-task.

14. The system of claim 13, wherein the first platform level comprises a Cloud platform level.

15. The system of claim 13, wherein the second platform level comprises multi-channels, wherein each multi-channel is one of a Smart Phone, a tablet, or a tablet.

16. The system of claim 13, wherein the different platform instances of the second platform level comprises different operating systems.

17. The system of claim 13, wherein the third platform level comprises multi-channels, wherein each multi-channel is one of a Smart Watch, a Smart Glasses, or a Smart Car.

18. The system of claim 1, wherein the different platform instances of the third platform level comprises different operating systems.

19. A method of operating a delegated business process management system, the method comprising:
designing and managing a business process having a plurality of tasks at a first platform level;
delegating a task of the plurality of tasks from the first platform level with accompanying ability and authorization to a device of a particular platform instance of a second platform level, wherein the accompanying ability and authorization for the device of the second level includes the ability and authorization to communicate with other systems to obtain data and to delegate the ability and authorization to complete a sub-task to a third platform level; and
delegating the sub-task from the device on the second platform level with accompanying ability and authorization to a device of a particular platform instance of the third platform level, wherein the accompanying ability and authorization includes the ability and authorization for the device of the third platform level to communicate with other systems to obtain data.

20. The method of claim 19, further comprising completing the tasks and sub-tasks on the respective platform level and communicating same to the first platform level.
